(19) United States
(12) Patent Application Publication
(10) Pub. No.: US 2001/0006264 A1
(43) Pub. Date: Jul. 5, 2001

(54) Method for controlling the curing of fiber composite materials

(76) Inventors: Fekko de Wit, Bremen (DE); Stefan Sauerwald, Horneburg (DE); Heike Lindhorst, Agathenburg (DE)

Correspondence Address: FASSE PATENT ATTORNEYS, P.A., P.O. BOX 726, HAMPDEN, ME, 04444-0726, US

(21) Appl. No.: 09/740,578

(22) Filed: Dec. 18, 2000

(30) Foreign Application Priority Data
Dec. 16, 1999 (DE) 199 60 726.5

(51) Int. Cl. B29C 35/02

(52) U.S. Cl. 264/40.1; 264/40.5; 264/40.6

(57) ABSTRACT

Curing of fiber composite materials is controlled by controlling in closed loop fashion the curing temperature, the curing pressure and/or curing time duration by control signals obtained from the curing of at least one separate test sample made of fiber composite material identical to the fiber composite material to be cured. One or more sensors are inserted into the test sample for sensing a curing characteristic such as the ion viscosity of the fiber composite material. The ion viscosity is a measure of the resistivity of the fiber composite material. The sensor or sensors produce respective electrical signals which represent the current degree of curing as a function of the ion viscosity or resistivity of the fiber composite material. The electrical signals obtained from the test sample or test samples are used for controlling the curing of the fiber composite materials either in real time or later. In both instances only the separate test sample is provided with sensors.

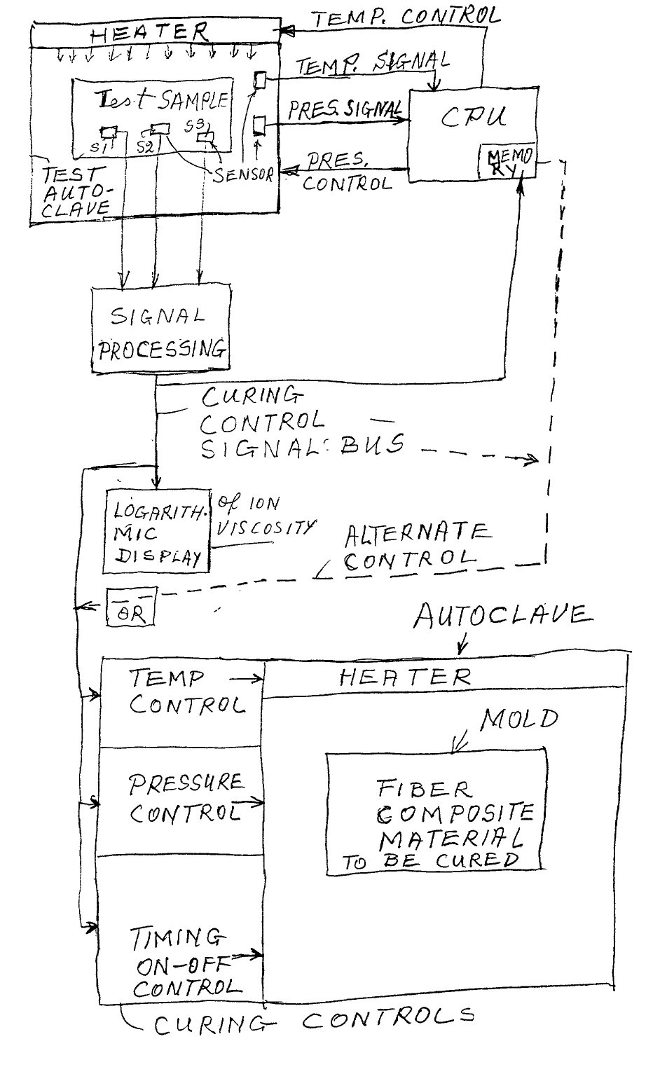

### PRIORITY CLAIM

This application is based on and claims the priority under 35 U.S.C. §119 of German Patent Application 199 60 726.5, filed on Dec. 16, 1999, the entire disclosure of which is incorporated herein by reference.

### FIELD OF THE INVENTION

The invention relates to a method for controlling the curing of fiber composite materials. The method is based on the fact that certain characteristics of a fiber composite material vary with the degree of curing.

### BACKGROUND INFORMATION

Fiber composite materials such as carbon fiber composite materials or glass fiber composite materials are cured by placing prepregs in the form of fibers embedded in a matrix material such as an epoxy resin, into a curing apparatus such as an autoclave in which the temperature, the pressure and the curing duration are controllable.

It is customary to control the curing duration or residence time of the fiber composite material in the autoclave primarily based on experience values. During the curing the fibers are bonded to the matrix material and the strength of the resulting fiber composite material depends on the forces that are effective in the bond between the fibers and the matrix material. These bonding forces in turn depend on chemical reactions that cause the curing. It is desirable to obtain an optimal curing under properly controlled curing conditions because the chemical reactions that cause the curing and bonding depend in a sensitive manner on deviations of the actual curing conditions in the autoclave from rated or given curing conditions provided for example by the manufacturer of the matrix material or of the prepregs. It is recognized that even small errors in the temperature and/or pressure conditions in the autoclave can lead to faulty curing resulting in an incomplete crosslinking. Both, under heating and over heating may lead to faulty curing. In both instances rejects are produced.

In order to deal with the foregoing problems or at least reduce the number of rejects, it is known to control the process parameters of the curing by reducing the temperatures and pressure control parameters to a safe level while increasing the curing time to avoid faulty curing. However, increasing the curing time in order to still achieve a complete crosslinking of the materials to be cured leads to an inefficient curing operation, particularly if the duration of curing cycles is prolonged to such an extent that safe curing is assured. Conventionally, long curing durations are used in order to directly assure the proper progress of the curing reaction while curing takes place slowly which is not efficient.

German Patent Publication 40 40 352 C2 discloses a method for manufacturing of structural components made of fiber composite material, wherein a bonding process is induced by pressure and heat. A heated medium is caused to flow through conduits in heating plates. The material to be cured or bonded is placed between the heating plates which introduce curing energy into the fiber composite material. As the curing reaction proceeds, measurements are made of the energy conversion over time and energy ratios are formed to provide information regarding the curing. More specifically, an energy conversion factor ascertained at a point of time (t) is compared with a previously measured energy conversion factor at a point of time (t−1) immediately ahead of the current time of measurement. The comparisons are continued until curing is completed. The energy supply is switched off only in case of an extreme drop in the energy conversion from a high value substantially to zero the energy supply is switched off. This conventional method leaves room for improvement, particularly with regard to the accuracy of the curing control.

### OBJECTS OF THE INVENTION

In view of the above it is the aim of the invention to achieve the following objects singly or in combination:

to assure a uniform curing quality and thus a uniform product quality by controlling the process parameters as precisely as possible without directly introducing curing status sensors into the material to be cured;

to improve the economy of curing fiber composite materials, specifically by reducing the number of rejects while simultaneously reducing the curing time;

to continuously measure the current, actually present curing degree based on the dielectric characteristic of the material being cured without invading the material as it is curing and to use the measuring results for generating control signals for the curing operation; and

to use the measuring results either directly in a closed loop control circuit for controlling the curing temperature pressure and time duration or to store this information and then use the stored information for controlling the respective curing parameters such as temperature, pressure and time.

### SUMMARY OF THE INVENTION

According to the invention there is provided a method for curing fiber composite materials which method is characterized by the following steps. First, at least one separate test sample is prepared of a fiber composite material that is identical to the fiber composite material to be cured. The preparation of the test sample includes inserting at least one sensor such as a dielectric sensor into the separate test sample for measuring at least one curing status for example preferably expressed in degrees of curing, whereby the uncured material corresponds to a 0% of full curing and 100% corresponds to completion of the curing. Second, the separate test sample is separately cured under controlled or rated curing conditions. Such conditions are usually provided by the manufacturer of the matrix material in which the reinforcing fibers of the fiber composite material are embedded. Third, the curing status of the test sample is measured with the at least one sensor during the separate curing of the at least one test sample to provide electrical signals which represent the current curing status of the test sample. Preferably, the curing status is measured repeatedly or continuously to provide or generate curing control signals. The curing control signals are used for controlling the curing of the fiber composite material either in real time simultaneously with sensing the test sample or the curing control signals are stored in a memory for controlling the curing of the fiber composite material at a later time. In both instances the fiber composite material is cured under controllable curing conditions such as temperature, pressure and time which are controlled in closed loop fashion by the curing control signals derived from the curing of the test sample. In both instances, the curing of the fiber composite material is stopped when a predetermined curing degree has been reached.

As mentioned above, the curing information according to the second embodiment is obtained in advance for curing the fiber composite material later. Such information is gathered by preparing at least one test sample of the fiber composite material which is to be cured, whereby the test sample is identical to the fiber composite material. At least one, preferably a plurality of sensors are inserted into the test sample, preferably into the matrix material of the test sample and distributed throughout the volume of the test sample. The test sample is then cured under controlled, predetermined curing conditions to provide rated or determined curing conditions for the fiber composite material. The sensors measure the curing status of the test sample while the test sample is being cured, to provide electrical signal representing the curing conditions or curing information and this information is stored in a memory for use in a subsequent curing of the fiber composite material, whereby the stored information can control the curing of identical materials without inserting sensor probes into the fiber composite materials. This advantage is achieved by both embodiments of the invention.

In a preferred embodiment the gathered information is displayed, preferably on a screen and still more preferable on a logarithmic scale for use by an operator. The pressure, temperature and time control of the actual curing of fiber composite materials is then performed in closed loop fashion in response to the gathered stored information while an operator can monitor the curing operation and make corrections manually if necessary.

### BRIEF DESCRIPTION OF THE DRAWING

In order that the invention may be clearly understood, it will now be described in connection with example embodiments, with reference to the accompanying drawing, wherein the single FIGURE is a block flow diagram of the method according to the invention.

### DETAILED DESCRIPTION OF PREFERRED EXAMPLE EMBODIMENTS AND OF THE BEST MODE OF THE INVENTION

The invention utilizes the ion viscosity for establishing degrees of curing which represent the rheologic viscosity of the fiber composite material being cured. The rheologic viscosity in turn is correlated to the reciprocal of the conductivity, more specifically, the resistivity or dielectric characteristic of the fiber composite material which changes as the curing progresses. By monitoring the ion or ionic viscosity until a complete curing of the fiber composite material is achieved, it is assured that the curing is stopped at a point of time which yields optimal characteristics of the cured material such as strength characteristics and aging characteristics.

According to the invention, the controlling of the curing conditions assures on the basis of dielectric measurements that optimal crosslinking conditions are provided during the curing. The termination of the curing can be precisely determined when the ion viscosity reaches its minimum thereby signifying that reactions of the composite materials have ended and no further crosslinking will take place. This minimum of the ion viscosity is clearly defined when a trailing edge of the measurement curve as a function of time, reaches its minimum. Asymptotic end values in the ionic viscosity curve permit making conclusions with regard to the completion of the crosslinking and thus on the beneficial characteristics of the cured fiber composite materials.

There is a direct relationship between the variations of the mechanical characteristics of the cured materials and the ionic viscosity. More specifically, when the ionic viscosity is large or at its maximum, curing is incomplete and the mechanical characteristics of the fiber composite material are essentially those of an uncured prepreg material. Experiments have shown that there is a correlation between the dielectric measurements that represent each point on the measured curve with the degree of crosslinking, which in turn permits correlating each point on the measurement curve to a corresponding quality of the lamination bonding in the fiber composite material where such a material comprises several layers of fibers and matrix material such as epoxy resins. By differentiating the measured values one obtains closed loop control values or respective signals which are used as control signals for the controlling of the curing parameters temperature, pressure and the curing duration with the aid of software it is possible to make a selection based on the “worst case scenario”, whereby the selection of respective representative control values forms the basis for the simultaneous gathering of the information from the test sample as the test sample is being cured. The gathered information is used in closed loop fashion in a real time control or, after storing the gathered information, in a subsequent curing process of the fiber composite material.

By relying on the curing of an external, or rather separate test sample for gathering the curing information, the invention provides an efficient curing operation because measurements directly in the structural component made of these fiber composite materials are avoided. Such direct measurements are not only expensive and time consuming, they are also harmful because inserting sensors directly into the structural component that is made of prepregs and then cured, can generate weak spots in the structural components. Additionally, the sensors are lost because they cannot efficiently be retrieved from the cured structural component. Moreover, providing the sensors with electrical connections that lead out of the fiber composite material is difficult to realize. The invention avoids these problems by using a separate test sample of fiber composite material that is made of fiber composite material identical to that to be cured. The test sample does not need to be in a mold or final shape as the products to be cured. A flat layered sample, for example, permits the insertion of the sensors more easily than inserting sensors into a configured prepreg component.

Other advantages of the invention are seen in that the quality of products cured according to the invention is improved due to the precise control in closed loop fashion of the curing parameters such as temperature, pressure and time. Moreover, it has been found that expensive final tests of the cured products can now be reduced to a minimum. According to the invention it is possible to unambiguously determine the actual curing degree which corresponds to the desired structural qualities of the cured product. Thus, unnecessary further curing after the optimal crosslinking has been achieved, is avoided according to the invention. Reducing the time required in the autoclave increases the economy of the present curing operation. Another advantage of the reduced time in the autoclave makes it possible to use structural component molds more efficiently or in the alternative expose the molds to a lesser degree of wear and tear.

A still further advantage is seen in that curing information gathered for a particular fiber composite material can be used repeatedly once the curing information has been obtained from a respective test sample.

The labels of the blocks in the single FIGURE are self-explanatory. According to the invention the sensors S1, S2, S3 in the test sample provide the curing control information which is processed for use as control signals for the curing of the fiber composite material in the mold. Thus, the invention avoids the use of sensors in the fiber composite material that is being cured in the mold, whereby the shape of the resulting fiber composite component is not disturbed by the insertion of sensors into the fiber composite material prior to curing. According to the invention the processed sensor signals are stored as control signals for later use or these signals are directly used for a concurrent curing of the fiber composite material and the test sample made of the same fiber composite material.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method for controlling the curing status of fiber composite materials, said method comprising the following steps:
a) preparing at least one separate test sample of said fiber composite material and inserting at least one sensor into said separate test sample for measuring at least one said curing status,
b) curing said fiber composite material under controllable curing conditions,
c) simultaneously and separately curing said separate test sample under controlled curing conditions,
d) measuring with said at least one sensor said curing status of said test sample during said separate but simultaneous curing of said at least one test sample to provide electrical control signals representing said curing status,
e) controlling in real time said controllable curing conditions in response to said electrical control signals in closed loop fashion, and
f) stopping said curing when a predetermined curing degree has been reached.

2. The method of claim 1, wherein said controlling step comprises individually controlling in real time said controllable curing conditions including any one of temperature, pressure, and curing time durations.

3. The method of claim 1, wherein said measuring step comprises sensing with said at least one sensor an electrical resistivity in said test sample.

4. The method of claim 1, wherein said measuring step ascertains an ion viscosity which is correlated to resistivity of said fiber composite material which resistivity changes as a function of curing of said test sample to provide said curing information as degrees of curing.

5. The method of claim 1, further comprising displaying said degrees of curing, preferably on a screen with a logarithmic scale.

6. The method of claim 1, further comprising inserting a plurality of sensors into said separate test sample of said fiber composite material.

7. The method of claim 1, wherein said measuring step comprises sensing a present ion viscosity of said test sample to provide said electrical control signals representing said curing status, determining from said present ion viscosity a completely cured status, and stopping said curing of said fiber composite material in response to said completely cured status.

8. The method of claim 1, further comprising inserting a plurality of sensors into a matrix material of said separate test sample and distributing said sensors throughout a volume of said matrix material.

9. A method for obtaining curing information for curing a fiber composite material, said method comprising the following steps:
(a) preparing at least one separate test sample of said fiber composite material which is to be cured,
(b) inserting at least one sensor into said test sample for measuring at least one curing status,
(c) curing said at least one test sample under controlled curing conditions corresponding to rated or determined curing conditions for said fiber composite material,
(d) measuring with said at least one sensor a curing status of said at least one separate test sample during said curing of said at least one test sample to provide electrical control signals representing said curing information, and
(e) storing said curing information in the form of said electrical control signals for a subsequent use in controlling curing conditions for said fiber composite material.

10. The method of claim 9, wherein said curing status is measured as a dielectric characteristic of said fiber composite material during said curing, wherein said dielectric characteristic is changing as a function of curing thereby providing said curing information as degrees of curing.

11. The method of claim 9, further comprising performing said measuring step at timed intervals or continuously.

12. The method of claim 11, wherein said timed intervals are correlated to degrees of curing between uncured 0% and fully cured equaling 100% of curing.

13. The method of claim 12, further comprising displaying said degrees of curing.

14. The method of claim 13, wherein said displaying is provided on a logarithmic scale.

15. The method of claim 9, further comprising inserting a plurality of sensors into said test sample of said fiber composite material.

16. The method of clam 15, wherein said plurality of sensors is inserted into a matrix material of said test sample made of said fiber composite material.

17. The method of claim 9, wherein said measuring step ascertains an ion viscosity which is correlated to resistivity of said fiber composite material which resistivity changes as a function of curing to provide said curing information.
